(19) United States
(12) Patent Application Publication
(10) Pub. No.: US 2005/0118543 A1
(43) Pub. Date: Jun. 2, 2005

(54) Photothermographic recording material

(75) Inventor: Hidetoshi Ezure, Tokyo (JP)

Correspondence Address: Finnegan, Henderson, Farabow,;Garrett & Dunner, L.L.P., 1300 I Street, N.W., Washington, DC, 20005-3315, US

(73) Assignee: KONICA MINOLTA MEDICAL & GRAPHIC, INC.

(21) Appl. No.: 10/984,801

(22) Filed: Nov. 10, 2004

(30) Foreign Application Priority Data
Nov. 13, 2003 (JP) JP2003-383485

(51) Int. Cl. G03C 1/00

(52) U.S. Cl. 430/619

(57) ABSTRACT

A photothermographic recording material comprising a substrate having thereon a light sensitive layer containing organic silver salt particles, silver halide particles and a reducing agent for silver ions, wherein a layer containing polyvinylidene chloride in an amount of at least 70 weight %, based on the total weight of the layer, is provided on at least one side of the substrate, and a vapor barrier layer containing a latex and a wax is appried on the outermost layer of the light sensitive layer.

### FIELD OF THE INVENTION

The present invention relates to a photothermographic recording material (hereinafter, referred to also as a photothermographic light sensitive material or a photothermographic material), and in particular to a photothermographic recording material which exhibits enhanced moisture resistance and improved blocking resistance (being a Japanese expression, being the tendency of sheet material sticking to each other due to humidity and their own weight).

### BACKGROUND OF THE INVENTION

Known are many photosensitized materials which have a light sensitive layer on a substrate, whereby an image is formed by imagewise exposure. Of these, listed is technology to form an image via thermal development as a system to promote environmental protection and image forming means.

In recent years, in the photochemical engraving fields, from the viewpoint of environmental protection and floor space saving, a decrease of processing effluent has been strongly demanded. As a result, techniques have been sought which relate to photothermographic materials which can be effectively exposed, employing laser imagers and laser image setters, and can form clear black-and-white images of high resolution. In these photothermographic recording materials, it is possible to provide a photothermographic processing system which eliminates use of aqueous processing chemicals and is simpler and more environmentally friendly.

Techniques to form an image via thermal development are described in, for example, U.S. Pat. Nos. 3,152,904 and 3,457,075; B. Morgan and B. Shely, “Thermally Processed Silver Systems, (Imaging Processes and Materials), Noblette 8th edition, edited by Sturge, V. Walworth and A. Shepp, page 2, 1969.

In cases when a light sensitive material for printing plate making is employed for color printing, generally, a plurality of films, separated for each color, is prepared. These films are printed to each machine plate, and the thus plates are overprinted. When plural color separated films are superimposed, and not perfectly overlapped, the resulting printed matter generates mackles of colors. Therefore, in photothermographic recording materials for printing plate making, one of the essential issues is how to suppress dimension change due to heat transferred to the plates. Methods to enhance dimensional stability under heat are described in Unexamined Japanese Patent Application Publication (hereinafter, referred to as JP-A) Nos. 10-10676 and 10-10677, which disclose a technique to minimize thermal shrinkage of the substrate due to heat treatment at a relatively high temperature of 80-200° C., while conveying at a low tension of 0.04-6 kg/cm².

Photothermographic recording materials comprise reducible silver sources (such as organic silver salts), photocatalysts of catalystic active mass (such as silver halides), and reducing agents for silver, which are commonly dispersed into an organic binder matrix. These photothermographic recording materials are stable at room temperature. However, when, after image exposure, they are heated to a relatively high temperature (for example, 80° C. or more), silver images can be formed through oxidation-reduction reaction between reducible silver sources (functioning as an oxidizing agent) and a reducing agent. The oxidation-reduction reaction is accelerated by catalystic action of a latent image generated via exposure. Silver, which is formed through the reaction of organic silver salts in the exposed area, provides a black image, while the unexposed area remains unchanged, whereby the contrast forms images.

These photothermographic recording materials tend to exhibit not enough high density due to low developing reaction with a small amount of water in the materials, such as in the low humidity of winter, and contrarily, in the high humidity of summer, the amount of water in the materials increases to accelerate developing reaction to increase speed (being sensitivity), resulting in a problem such as thickened text line width.

Under conventional technology, polyvinylidene chloride is employed in a protective layer to decrease the effects of thickened text line width under high humidity conditions (please refer to, for example, Patent Document 1), in which polyvinylidene chloride is employed in a subbing layer to minimize the effects of dimension changes with humidity (please refer to, for example, Patent Document 2), however, this technology resulted in environmental problems. Further, known are technologies to increase the thickness of a protective layer to ensure density under low humidity (please refer to, for example, Patent Document 3), and to minimize changes of text line width under high humidity by controlling drying temperatures (please refer to, for example, Patent Document 4), but these technologies were insufficient.

Further, the inventor of the present invention has diligently studied the problems, to result in improvement of humidity resistance of photographic characteristics with coating of an aqueous coating composition containing a mixture of a specific latex and wax emulsion, but the study thereafter proved that abrasion resistance was insufficient.

Patent Document 1: JP-A 2001-272742

Patent Document 2: JP-A 2001-287298

Patent Document 3: JP-A 2001-249425

Patent Document 4: JP-A 2002-55413

To overcome the foregoing problems, the inventor discloses a technology to provide a protective layer containing a latex and a wax in the outermost layer of the light sensitive layer side, however it was proved that humidity resistance was insufficient and blocking resistance was inferior with the above technology, under the rapid changes of temperature and humidity, such as during a typhoon during the rainy season.

### SUMMARY OF THE INVENTION

Accordingly, an object of the present invention is to provide a photothermographic recording material which exhibits improved humidity resistance and blocking resistance.

The foregoing object of this invention can be accomplished by the following embodiments.

1. A photothermographic recording material comprising a substrate having thereon a light sensitive layer comprising organic silver salt particles, silver halide particles and a reducing agent for silver ions,
wherein a layer containing polyvinylidene chloride in an amount of at least 70 weight % based on the total weight of the layer is provided on at least one side of the substrate, and
a vapor barrier layer comprising a latex and a wax on the outermost layer of the light sensitive layer is provided.

2. The photothermographic recording material of 1. above, wherein a water vapor transmission rate of the vapor barrier layer is 1 to 40 g/m²·24 hr.

3. The photothermographic recording material of 1. or 2. above, wherein the layer containing polyvinylidene chloride is provided on the light sensitive layer side.

4. The photothermographic recording material of any one of 1.-3. above, wherein the light sensitive layer is formed via a solvent coating method.

5. The photothermographic recording material of any one of 1.-4. above, wherein the light sensitive layer comprises a nucleating agent represented by following Formula (C-1), (C-2) or (C-3);

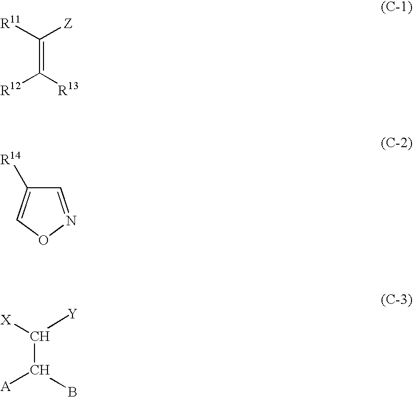

In Formula. (C-1), R¹¹, R¹² and R¹³ are each independently a hydrogen atom or a substituent group, Z is an electron attractive group or a silyl group, provided that R¹¹ and Z, R¹² and R¹³ , as well as R¹³ and Z may each combine with each other to form a cyclic structure.

Further, in Formula (C-2), R¹⁴ is a substituent group. Further, in Formula (C-3), X and Y are each independently a hydrogen atom or a substituent group, A and B are each independently an alkoxy group, an alkylthio group, an alkylamino group, an arythio group, an anilino group, a heterocyclic oxy group, a heterocyclic thio group, or a heterocyclic amino group, provided that X and Y, as well as A and B, may each combine with each other to form a cyclic structure.

6. The photothermographic recording material of any one of 1.-5., wherein the substrate is a low heat shrinkable substrate.

7. The photothermographic recording material of any one of 1.-6., wherein the silver iodide content of the silver halide particles is 5-100 mol %.

Namely, as a result of the diligent study of the above problems, the inventor of this invention found that a photothermographic recording material being superior in humidity resistance of photographic characteristics even in the case of rapid changes of temperature and humidity at a typhoon in the rainy seasons, was obtainable by providing a layer containing a polyvinylidene chloride copolymer on a substrate, and further providing a water vapor barrier layer containing a latex and a wax on the outermost layer of the material.

The photothermographic recording material of the present invention exhibits excellent effects of improved humidity resistance and blocking resistance.

### DESCRIPTION OF PREFERRED EMBODIMENTS

The present invention will now be described in detail.

Polyvinylidene Chloride

The present invention is characterized by having a layer containing polyvinylidene chloride in an amount of at least 70 weight % based on the total weight of the layer on at least one side of the substrate.

The layer containing polyvinylidene chloride at least 70 weight % is the layer having a content of polyvinylidene chloride components being not less than 70 weight % in that layer.

Further, to incorporate polyvinylidene chloride, a monopolymer of polyvinylidene chloride may be employed, but from the viewpoint of coatability and film formability, it is preferred to employ copolymers of polyvinylidene chloride. A polyvinylidene chloride component is preferably 70-100 weight %, and more preferably 80-100 weight %. In cases when it is less than 70 weight %, a damp proof effect may not be exhibited, resulting in deterioration of humidity resistance of the photographic characteristics.

The above layer containing polyvinylidene chloride is provided on at least one side of the substrate, but is preferably provided on both sides. When provided on only one side of the substrate, the layer is more preferably provided on the light sensitive layer side, from the viewpoint of preventing reduced desirable effects of the light sensitive layer due to penetration of water.

The thickness of the layer containing polyvinylidene chloride, coated on one side of the substrate, is preferably 0.1-10 μm, more preferably 0.3-8 μm, and specifically preferably 0.5-5 μm. In cases when the thickness is less than 0.1 μm, it is not preferable due to lack of humidity resistance. Further, when the thickness exceeds 10 μm, the layer becomes yellow-tinged, which is of course not preferred for photosensitive material.

In cases when the layer containing polyvinylidene chloride is coated on a substrate, the layer is preferably subjected to an annealing treatment at 40-70° C. from the viewpoint of enhancing moisture proof property. The annealing treatment may be conducted while conveying after coating, or conducted after winding up in a roll.

In this invention, a polyvinylidene chloride copolymer is preferably employed as polyvinylidene chloride. As examples of preferable copolymers containing polyvinylidene chloride, listed are copolymers consisting of vinylidene chloride/acrylic acid ester/vinyl monomers having alcohol in the side chain described in JP-A 51-135526, copolymers consisting of vinylidene chloride/alkylacrylate/acrylic acid described in U.S. Pat. No. 2,852,378, and copolymers consisting of vinylidene chloride/acrylonitrile/itaconic acid described in U.S. Pat. No. 2,698,235. As specific examples, listed are the following.

Numbers in parentheses are respective weight ratios.

Copolymer of vinylidene chloride: methyl acrylate hydroxyethyl acrylate (83:15:2)

Copolymer of vinylidene chloride: ethyl methacrylate hydroxypropyl acrylate (82:10:8)

Copolymer of vinylidene chloride: hydroxydiethyl methacrylate (92:8)

Copolymer of vinylidene chloride: butyl acrylate: acrylic acid (94:4:2)

Copolymer of vinylidene chloride: butyl acrylate: itaconic acid (75:20:5)

Copolymer of vinylidene chloride: methyl acrylate itaconic acid (90:8:2)

Copolymer of vinylidene chloride: methyl acrylate methacrylic acid (93:4:3)

Copolymer of vinylidene chloride: itaconic acid monoethyl ester (96:4)

Copolymer of vinylidene chloride: acrylonitrile acrylic acid (95:3.5:1.5)

Copolymer of vinylidene chloride: methyl acrylate: acrylic acid (90:5:5)

Copolymer of vinylidene chloride: ethyl acrylate acrylic acid (93:5:2)

Copolymer of vinylidene chloride: methyl acrylate: 3-chloro-2-hydroxypropyl acrylate (84:9:7)

Copolymer of vinylidene chloride: methyl acrylate: N-ethanolacrylamide (85:10:5)

Copolymer of vinylidene chloride: methyl acrylate: acrylic acid (98:1:1)

Copolymer of vinylidene chloride: methyl acrylate: itaconic acid (97:1:2)

Copolymer of vinylidene chloride: acrylonitrile acrylic acid (99:0.5:0.5)

Copolymer of vinylidene chloride: ethyl acrylate acrylic-acid (65:34:1)

Copolymer of vinylidene chloride: methyl acrylate itaconic acid (70:29:1)

Copolymer of vinylidene chloride: acrylonitrile acrylic acid (70:29:1)

Copolymer of vinylidene chloride: ethyl acrylate acrylic acid (68:31:1)

The vapor barrier layer of this invention is characterized by being provided at the outermost layer of the light sensitive layer side and containing a latex and a wax emulsion. The ratio of a latex to a wax emulsion is preferably 100:2-100:100, and more preferably 100:10-100:50. In cases when it is less than 100:2, the targeted moisture proof effect is not exhibited, resulting in deterioration of humidity resistance of photographic characteristics. Further, when it exceeds 100:100 due to the amount of wax being too much, the layer strength is weakened, resulting in deterioration of blocking resistance.

The water vapor transmission rate of the vapor barrier layer of this invention is preferably 1-40 g/m²·24 hr, and more preferably 1-20 g/m²·24 hr. In cases when it is less than 1 g/m²·24 hr, the wax ratio needs to be higher, and thus, layer strength is weakened, resulting in deterioration of blocking resistance.

Further, if it exceeds 40 g/m²·24 hr, the desired moisture proofing effect is not exhibited, resulting in deterioration of humidity resistance of photographic characteristics.

A measuring method of the water vapor transmission rate is described in JIS-Z-208 (the Dish Method).

Latex

The latex of this invention is not specifically limited, but preferred is a latex of a synthetic resin type or a synthetic rubber type from the viewpoint of blocking resistance and film forming properties. A synthetic resin type is specifically preferable.

The latex of this invention refers to polymer components in a dispersion in which the water-insoluble hydrophobic polymer is dispersed in water, or a water-soluble dispersion medium, in the form of minute particles. Dispersion states may be any of the following states: the polymer is emulsified in a dispersion medium in a dispersed state; the polymer is formed employing emulsion polymerization; the polymer is subjected to micelle dispersion; or the polymer has a partial hydrophilic structure in the molecule, and the molecular chain itself is subjected to molecular dispersion. Latexes-Of this invention are described for example in, “Gosei Jushi Emulsion (Synthetic Resin Emulsion)”, edited by Taira Okuda and Hiroshi Inagaki, published by Kobunshi Kankokai (1978); “Gosei Latex no Oyo (Application of Synthetic Latexes)”, edited by Takaaki Sugimura, Yasuo Kataoka, Soichi Suzuki, and Keiji Kasahara, published by Kobunshi Kankokai (1993); and Soichi Muroi, and “Gosei Latex no Kagaku (Chemistry of Synthetic Latexes)”, published by Kobunshi Kankokai (1970).

The Tg of the polymers comprising latex is preferably −20 to 60° C., and more preferably 0-50° C. In cases when it is less than −20° C., fluidity occurs in the layer, resulting in deterioration of blocking resistance. Further, when it exceeds 60° C., film-forming properties are deteriorated and the desired moisture proofing effect is not realized, resulting in deterioration of humidity resistance of photographic characteristics. Tg of latex (being the glass transition temperature) is a value determined by calculation with a method by T. G. Fox, described in Bull. Am. Phys. Soc., 1956. In cases when plural latexes are mixed and employed, Tg is determined based on the weight ratio of comprised latexes.

The average particle diameter of dispersed particles of latex is preferably in the range of 1-50,000 nm, but more preferably in the range of 1-1,000 nm. Regarding particle diameter distribution of dispersed particles, latexes having either a wide distribution or a monodispersed particle distribution are preferablly employed.

As latexes of this invention, a so-called core/shell type latex may be employed, other than a latex of normal uniform composition. In this case, sometimes it is preferable that the core and shell have a different Tg or composition. Further, the use of more than two kinds of latex is preferred to obtain a balance of film-forming properties, moisture proofing and blocking resistance. In this case, the Tg and composition may be appropriately adjuste, as well as the core/shell type.

The latex of this invention is obtained with emulsion polymerization of a monomer, such as the following ethylenic unsaturated monomer. As surface active agents used in this case, employable are cationic surface active agents, nonionic surface active agents, anionic surface active agents and amphoteric surface active agents, all of which are readily available on the market. Of these, it is preferable to employ a reactive emulsifying agent to enhance the moisture proofing effect. By employing this reactive emulsifying agent, a soap-free type emulsion can be obtained. Examples of reactive emulsifying agents include, for example, sodium styrene sulfonate, sodium vinyl sulfonate, and various emulsifying agents having an ethylenic unsaturated group. Of these, specifically preferable are the following compounds described in JP-A 58-203960.

Synthetic Resin Latex

Synthetic resin latex is produced as a polymer of the following ethylenic unsaturated monomer, or a copolymer of the following ethylenic unsaturated monomers, a plurality of which may be combined. As examples of ethylenic unsaturated monomers, listed are acrylic acid alkyl esters and methacrylic acid alkyl esters exemplified by methyl acrylate, ethyl acrylate, ethyl methacrylate, propyl acrylate, propyl methacrylate, butyl acrylate, butyl methacrylate, hexyl acrylate, hexyl methacrylate, heptyl acrylate, heptyl methacrylate, octyl acrylate, octyl methacrylate, octadecyl acrylate, and octadecyl methacrylate; aliphatic conjugated diene monomers such as 1,2-butadiene, 1,3-butadiene, isoprene, and chloroprene; ethylenic unsaturated aromatic monomers such as styrene, α-methyl styrene, vinyl toluene, chlorostyrene, and 2,4-dibromostyrene; unsaturated nitrile such as acrylonitrile, and methacrylonitrile; ethylenic unsaturated carboxylic acid such as acrylic acid, methacrylic acid, crotonic acid, maleic acid and its anhydride, fumaric acid, itaconic acid, and unsaturated dicarboxylic acid monoalkyl esters e. g. monomethyl maleate, monoethyl fumalate, and itaconic acid mononormalbutyl; vinyl esters such as vinyl acetate, and vinyl propionate; vinylidene halides such as vinylidene chloride, and vinylidene bronide; hydroxyalkyl esters of ethylenic unsaturated carboxyl acid such as acrylic acid-2-hydroxyethyl, acrylic acid-2-hydroxypropyle, and methacrylic acid-2-hydroxyethyl; monomers capable of radical polymerization such as glycidyl esters of ethylenic unsaturated carboxylic acids e. g. glycidyl acrylate, and glycidyl methacrylate, and acrylamide, methacrylamide, N-methylolacrylamide, N-methylolmethacrylamide, N-butoxymethylacrylamide, and diacetoneacrylamide, and acetoacetoxy esters having an active methylene group e. g. 2-acetoacetoxyethyl methacrylate, 2-acetoacetoxyethyl acrylate, 2-acetoacetoxypropyl methacrylate, and 2-acetoacetoxypropyl acrylate.

Of these, preferred are the ones which have a functional group capable of chemical bonding, to enhance humidity resistance and abrasion resistance. Specifically preferred is one having a glycidyl group or an active methylene group.

A functional group is preferably 5-80% based on the latex component, but more preferably 20-60%. In cases when it is less than 5%, humidity resistance and abrasion resistance are deteriorated, exhibiting undesirable results. Further, when it exceeds 80%, stability of the latex is deteriorated to allow the possibility of undesirable defects during coating.

Wax Emulsion

A wax emulsion of this invention is obviously obtained by emulsification of a wax. Waxes include: paraffin wax, candelilla wax, carnauba wax, rice wax, ceresine wax, petrolatum wax, Fitscher-Tropsch wax, polyethylene wax, montan wax and its derivatives, micro-crystalline wax and its derivatives, hardened caster oil, liquid paraffin, and stearic acid amide, of which paraffin wax is specifically preferred. Further, methods to prepare these wax emulsions may be any of the well-known methods in the art, for example, a wax, resin, and a fluidizing agent are mixed and heated until fused, and an emulsifying agent is added thereto, after which the mixture is subjected to emulsification. Resins include rosins, rosin ester compounds, and petroleum resins. After fusion, added to the mixture, are a surface active agent such as an anionic, cationic, or a nonionic surface active agent, a basic compound such as ammonia, sodium hydroxide, potassium chloride, an organic amine, or a styrene-maleic acid copolymer, which are then emulsified.

A wax emulsion may be-employed alone or in combination of more than two kinds.

The melting point of the wax emulsion determined by a differential scanning calorimeter (DSC) is preferably 40-100° C., but more preferably 50-80° C. A melting point of less than 40° C., is undesirable due to deterioration of blocking resistance. Further, when it is more than 100° C., the wax is not sufficiently softened and fluidized, and the moisture proofing effect is impaired, resulting in deterioration of humidity resistance.

Film Forming Auxiliary Agent

A film forming auxiliary agent of this invention is not specifically limited, as long as it accelerates film formation of a coating composition the main component of which is a latex. Listed as the preferred ones, are organic compounds capable of plasticizing the outer portion of polymers and exhibiting a boiling point of more than 250° C.; organic solvents having an affinity for the latex polymers; and elastomers. The above film forming auxiliary agent may be used alone or in combination with more than two kinds.

As a plasticizer contained in the polymer latex, preferred is an organic compound capable of plasticizing the outer portion of the polymers and having a boiling point of more than 250° C. Specifically, listed examples are: phthalic acid esters such as dibutyl phthalate; glycol derivatives such as diethylene glycol, diethylene plycol dioctyl ether, and triethylene acetate glycol; phosphoric esters triphenyl phosphate, and tridecyl phosphate; and ketones such as cyclodecane, n-octadecane, and n-octadecane-3,6,9-trione. The addition method of the plasticizer to the latex is not limited, but listed examples are: direct addition to the latex solution, or addition after being emulsified with an emulsifying agent.

Organic solvents having an affinity for the latex polymer are not specifically limited, as long as the boiling point is not more than 250° C. Specifically, cellosolves such as: ethyl cellosolve, isopropyl cellosolve, and butyl cellosolve; alcohols such as isopropanol, n-butanol, sec-butano, and furfuryl alcohol; glycols such as diethylene blycol monoethyl ether, as well as ethylene acetate glycol monoethyl ether, and their derivatives. The addition method of the film forming auxiliary agent to the latex is not specifically limited, but preferred is direct addition to the latex, or addition after being dissolved in monomers during polymerization. Further, specifically preferred is direct addition to the latex, from the viewpoint of degree of freedom for the addition amount and substitution of solvents. To cushion the shock to the latex, it is more preferable that the film forming auxiliary agent is added to the latex after it is diluted with water or with an organic solvent having a low affinity for the latex.

As elastomers, preferred is a latex polymer having a low glass transmission temperature, being less than 0° C., more preferably −20° C. The polymer content is not specifically limited.

The added amount of the film forming auxiliary agent is not specifically limited, but it is preferably in the range of 0.01-5 weight % based on the polymer component in the outermost layer, and specifically preferably in the range of 0.01-3 weight %. Further preferably it is in the range of 0.01-1 weight %. In cases when the film forming auxiliary agent is less than 0.01%, the accelerated film forming effect is decreased, resulting in deterioration of abrasion resistance. On the other hand, when the film forming auxiliary agent is more than 5%, the layer strength is weakened by the film forming auxiliary agent itself, resulting in undesirable deterioration of abrasion resistance as well as heat resistance.

Others

Further, to the vapor barrier layer of this invention, a cross-linking agent may be added. By employing a cross-linking agent in combination with the above latex and emulsion wax, the water proofing effect and humidity resistance are enhanced. The cross-linking agents usable in this invention include various cross-linking agents which are employed in conventional photographic sensitive materials, for example, an/a: aldehyde type, epoxy type, ethyleneimine type, vinyl sulfone type, sulfonic acid ester type, acryloyl type, and carbodiimide type cross-linking agents which are described in JP-A 50-96216.

Further, to the vapor barrier layer of this invention, a matting agent may be employed to enhance abrasion resistance. In this invention, micro-particles added as a matting agent are generally a water-insoluble inorganic or organic compound, however other appropriate ones may be employed. Any of the micro-particles well-known in the art may be employed, such as organic matting agents described in U.S. Pat. Nos. 1,939,213, 2,701,245, 2,322,037, 3,539,344, and 3,767,448; and inorganic matting agents described in U.S. Pat. Nos. 1,260,772, 2,192,241, 3,257,206, 3,370,951, 3,523,022, and 3,769,020. The above matting agents may be used in combination with different substances, if optimal. The size and shape of the matting agent particles are not specifically limited, and the matting agent having an optional particle diameter may be employed. In the practice of this invention, it is preferable to employ one having a particle diameter of 1-30 μm. Further, the particle diameter distribution may be wide or narrow. On the contrary, since the matting agent significantly affects haze and surface glossiness of the photosensitive material, it is preferable that the particle diameter, shape and particle diameter distribution are adjusted as necessary, during production of the matting agent, or by mixing of plural matting agents.

Light Sensitive Layer

Organic Silver Salt

The organic silver salt incorporated in the light sensitive layer of the photothermographic recording material of this invention is a reducible silver source, being a silver salt of an organic acid or a hetero organic acid which contains a reducible silver source, and specifically preferably is a long chain aliphatic carboxylic acid (having 10-30 carbon atoms, preferably 15-25), or a nitrogen incorporating heterocyclic carboxylic acid. Organic or inorganic silver salt complexes, a ligand of which has a total stability constant for a silver ion of 4.0-10.0, are also useful. Preferable examples of the silver salts are described in Research Disclosure (hereinafter, referred to as RD), Nos. 17029 and 29963, and are the following. Listed are organic acid salts, such as salts of gallic acid, oxalic acid, behenic acid, stearic acid palmitic acid, and lauric acid; carboxyalkyl thiourea salts of silver, such as 1-(3-carboxypropyl)thiourea, and 1-(3-carboxypropyl)-3,3-dimethyl thiourea; silver complexes of polymer reaction products of aldehyde and hydroxy-substituted aromatic carboxylic acid, such as aldehydes, e. g. formaldehyde, acetoaldehyde, or butylaldehyde, as well as hydroxy-substituted acid, e. g. salicylic acid, benzyl acid, 3,5-dihydroxybenzoic acid, or 5,5-thiodisalicylic acid; silver salts or complexes of thiones, such as 3-(2-carboxyethyl)-4-hydroxymethyl-4-thiazoline-2-thione, and 3-carboxymethyl-4-methyl-4-thiazoline-2-thione; complexes or salts of silver and a nitrogen acid from, for example, imidazole, pyrazole, urazole, 1,2,4-thiazole and 1H-tetrazole, as well as 3-amino-5-benzylthio-1,2,4-triazole and benzotriazole; a silver salt of saccharin or 5-chlorosalicyl aldoxyme. Preferable silver sources are silver behenate, silver arachidinate and silver stearate.

The organic silver salt is obtained by mixing a water soluble silver compound and a complexing compound with silver. Preferably employed are a normal precipitation method, a reverse precipitation method, a double-jet method, and a controlled double-jet method, described in JP-A 9-127643. For example, after preparation of organic acid alkali metal salt soap (such as sodium behenate and sodium arachidinate) by addition of alkali metal salt (such as sodium hydroxide and potassium hydroxide) to an organic acid, the foregoing soap and silver nitrate are added via a controlled double-jet method, to obtain crystals of the organic silver salt. In that case, silver halide particles may be concurrently presented.

Silver Halide

Silver halide particles contained in the light sensitive layer of the photothermographic recording material of this invention function as a light sensors. In this invention, to minimize cloudiness after image formation and to obtain excellent image quality, the lower the average particle size, the more preferred, and further the average particle size is,preferably not more than 0.03 μm, but more preferably in the range of 0.01 to 0.03 μm. Further, the silver halide particles of the photothermographic recording material of this invention may be prepared at the same time as preparation of the foregoing organic silver salt, or may be prepared when concurrently introduced with the foregoing organic silver salts during preparation thereof. It is preferable that by these methods, the silver halide particles are formed in a state in which the silver halide particles are fused to the organic silver salts, resulting in so-called in-situ silver. The method to determine the average particle diameter of the above silver halide particles is to visualize the photograph at an enlargement of 50,000 using an electron microscope, after which the makor and minor axis of each of 100 random silver halide particles are measured, after which, the figures are averaged to obtain the average particle diameter.

The average particle diameter as described herein is defined as the average edge length of silver halide particles, in cases where they are so-called regular crystals in the form of a cube or octahedron. Further, in cases where particles are not regular crystals, for example, being spherical grains, bar-like grains, and tabular grains, the average particle diameter means the diameter of a sphere having the same volume as a silver halide particle. Further, silver halide particles are preferably monodispersed particles. The monodispersed particles as described herein refer to particles having a degree of monodispersion, obtained by the formula described below, of at most 40%, more preferably at most 30%, still more preferably is 0.1-20%.
Degree of monodispersion=(standard deviation of particle diameter)/(average particle diameter)×100

In this invention, silver halide particles preferably have an average particle diameter of 0.01-0.03 μm, and are also monodispersed particles, whereby graininess is enhanced by the average particle diameter being set in this range.

Shape of the silver halide particles is not specifically limited, but the ratio of the crystal face having a Miller index of [100] is preferably high, and this ratio is preferably at least 50%, more preferably at least 70%, and still more preferably at least 80%. The ratio accounted for by the Miller index [100] face can be obtained based on T. Tani, J. Imaging Sci., 29, 165 (1985) in which adsorption dependency of a [111] face or a [100] face is utilized.

Further, another preferable shape of the silver halide particles is tabular. A tabular particle as described herein means a particle having an aspect ratio of at least 3, whereby the aspect ratio is defined as r/h, where a square root of the projected area is assumed to be r μm, and the thickness in the vertical direction being h μm. Of these, preferred are particles having the aspect ratio between 3-50. Further, the particle diameter is preferably at most 0.03 μm, but more preferably 0.01-0.03 μm. The production methods of these particles are described in U.S. Pat. Nos. 5,264,337, 5,314,798, and 5,320,958, whereby the desired tabular particles may be readily obtained. In this invention, the use of the tabular particles further enhances image sharpness.

The halide of silver halide is not specifically limited and may be silver chloride, silver chlorobromide, silver iodochlorobromide, silver bromide, silver iodobromide or silver iodide. The silver halide emulsion used in this invention can be prepared employing the methods described in P. Glafkides, Chimie et Physique Photographique (published by Paul Montel Corp., 1967); G. F. Duffin, Photographic Emulsion Chemistry (published by The Focal Press, 1966); and V. L. Zelikman et al., Making and Coating of Photographic Emulsion (published by The Focal Press, 1964).

To reduce reciprocity law failure and to adjust gradation, the silver halide particles used in this invention preferably contain ions or complex ions of metals belonging to Groups 6-11 of the Periodic Table. Preferred as the above metals are W, Fe, Co, Ni, Cu, Ru, Rh, Pd, Re, Os, Ir, Pt and Au.

Silver halide particles are subjected to desalting to remove soluble salts by common washing methods known in the art, such as a noodle washing method, or a flocculation method, but in this invention, desalting may be optional.

The silver halide particles of this invention are preferably subjected to chemical sensitization. As preferable chemical sensitization methods, employed may be any of these known in the art, such as a sulfur sensitization method, -a selenium sensitization method, a tellurium sensitization method, a noble metal sensitization method using compounds of gold, platinum, palladium, and iridium, or a reduction sensitization method.

In this invention, to minimize hazing of the photothermographic recording material, the total amount of silver halide particles and organic silver salt is preferably 0.3-2.2 g per m² in an equivalent amount converted to silver, but more preferably 0.5-1.5 g. By allowing the total silver amount to set within this range, high contrast images can be obtained. Further, the amount of silver halide based on the total silver amount is preferably at most 50% by weight, more preferably at most 25%, and still more preferably in the range of 0.1-15%.

The silver halide particles of this invention have an absorption maximum of 350-450 μm, and generally contain no spectral sensitizing dye, but may contain one, if appropriate.

Reducing Agent

Preferable examples of reducing agents, incorporated in the light sensitive layer of the photothermographic recording material of this invention, are described in U.S. Pat. Nos. 3,770,448, 3,773,512, and 3,593,863, and are listed below:

Aminohydroxy cycloalkenone compounds, such as 2,-hydroxy-3-piperidino-2-cyclohexenone; reducing agent precursors of amino reductones esters, such as piperidinohexose reductone monoacetate; N-hydroxyurea derivatives, such as N-p-methylphenyl-N-hydroxyurea; hydrazones of aldehydes or ketones, such as anthrasene aldehyde phenylhydrazone; phospheramide-phenols; phospheramide anilines;.polyhydroxybenzenes, such as hydroquinone, t-butyl-hydroquinone, isopropylhydroquinone, and (2,5-dihydroxy-phenyl)methylsulfone; sulfohydroxamic acids, such as benzenesulfohydroxamic acid; sulfonamide anilines, such as 2-methyl-5-(l-phenyl-5-tetrazolylthio)hydroquinone; tetrahydroquinoxalines, such as 1,2,3,4-tetrahydroquinoxaline; amidoximes; azines; a combination of aliphatic carboxylic acid arylhydrazides and ascorbic acid; a combination of polyhydroxybenzene and, hydroxylamines; reductones or hydrazine; hydroxane acids; a combination of azines and sulfonamide phenols; (α-cyanophenylacetic acid derivatives; a combination of bis-β-naphthol and 1,3-dihydroxybenzene derivatives; 5-pirazolones; sulfonamide phenol reducing agents; 2-phenylindane-1,3-dione; chromane; 1,4-dihydropirizines, such as 2,6-dimethoxy-3,5-dicarboethoxy-1,4-dihydropirizine; bisphenols, such as bis(2-hydroxy-3-t-butyl-5-methylphenyl)methane, bis(6-hydroxy-m-tri)propane, 4,4-ethylidene-bis(2-t-butyl-6-methylphenol); UV responsive ascorbic acid derivatives; hindered phenols; and 3-pyrazolidones. Of these, specifically preferable reducing agents are hindered phenols.

The added amount of the reducing agent is preferably 1×10⁻²-10 mol per mol of silver, and specifically preferable is 1×10⁻²-1.5 mol.

Nucleating Agent (Contrast Increasing Agent)

The contrast increasing agents incorporated in the light sensitive layer of the photothermographic recording material of this invention include: hydrazine compounds described in RD No. 23515 (Nov., 1983, pg. 346) and documents cited therein; U.S. Pat. Nos. 4,080,207, 4,269,929, 4,276,364, 4,278,748, 4,385,108, 4,459,347, 4,478,928, 4,560,638, 4,686,167, 4,912,016, 4,988,604, 4,994,365, 5,041,355, and 5,104,769; British Patent No. 2,011,391B; European Patent Nos. 217,310, 301,799, and 356,898; and JP-A Nos. 60-179734, 61-170733, 61-270744, 62-178246, 62-270948, 63-29751, 63-32538, 63-104047, 63-121838, 63-129337, 63-223744, 63-234244, 63-234245, 63-234246, 63-294552, 63-306438, 64-10233, 1-90439, 1-100530, 1-105941, 1-105943, 1-276128, 1-280747, 1-283548, 1-283549, 1-285940, 2-2541, 2-77057, 2-139538, 2-196234, 2-196235, 2-198440, 2-198441, 2-198442, 2-220042, 2-221953, 2-221954, 2-285342, 2-285343, 2-289843, 2-302750, 2-304550, 3-37642, 3-54549, 3-125134, 3-184039, 3-240036, 3-240037, 3-259240, 3-280038, 3-282536, 4-51143, 4-56842, 4-84134, 4-96053, 4-216544, 5-45761, 5-45762, 5-45763, 5-45764, 5-45765, 6-289524, and 9-160164.

In addition to these, employable are compounds represented by (Chemical Structures 1), described in Examined Japanese Patent Application Publication (hereinafter, referred to as JP-B) 6-77138, pp. 3 and 4; compounds of Nos. 1-36, represented by Formula (1) in JP-B 6-93082, pp. 1-18; compounds represented by Formulas (4)-(6), described in JP-A 6-23049, specifically compounds 4-1-4-10 on pp. 25 and 26, 5-1-5-42 on pp. 28-36, and 6-1-6-7 on pp. 39 and 40; compounds represented by Formulas (1) and (2), described in JP-A 6-289520, specifically compounds 1-1)-1-17) and 2-1) on pp. 5-7; compounds described in JP-A 6-313936, represented by (Chemical structures 2) and (Chemical Structures 3), and specifically compounds described on pp. 6-19; compounds described in JP-A 6-313951, represented by (Chemical. Structures 1), and specifically compounds described on pp. 3-5; compounds described in JP-A 7-5610, and represented by Formula (1), and specifically compounds of I-1-I-38, described on pp. 5-10; compounds described in JP-A 7-77783, and represented by Formula (II), and specifically compounds of II-1-II-102, described on pp. 10-27; and compounds described in JP-A 7-104426, and represented by Formulas (H) and (Ha), and specifically compounds of H-1-H-44, described on pp. 8-15.

Further, other contrast increasing agents used in this invention include compounds described in JP-A 11-316437, pp. 33-53, but more preferably employed are vinyl compounds represented by foregoing Formula (C-1), (C-2) and (C-3), described in JP-A 2000-298327.

In Formula (C-1), R¹¹, R¹² and R¹³ are each independently a hydrogen atom or a substituent group, Z is an electron attractive group or a silyl group, provided that R¹¹ and Z, R¹² and R¹³, and R¹³ and Z may combine with each other to form a cyclic structure.

Further, in Formula (C-2), R¹⁴ is a substituent group. In Formula (C-3), X and Y are each independently a hydrogen atom or a substituent group, A and B are each independently an alkoxy group, an alkylthio group, an alkylamino group, an arythio group, an anilino group, a heterocyclic oxy group, a heterocyclic thio group, or a heterocyclic amino group, provided that X and Y and A and B, in which each pair may combine with each other to form a cyclic structure.

Specific examples of compounds of the above Formulas (C-1), (C-2) and (C-3) include the following compounds, but this invention is not limited these compounds.

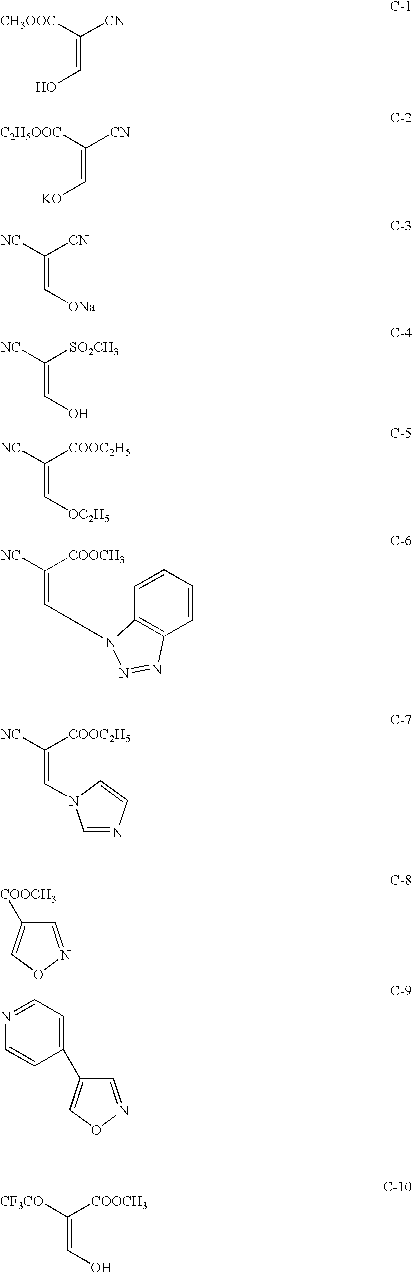

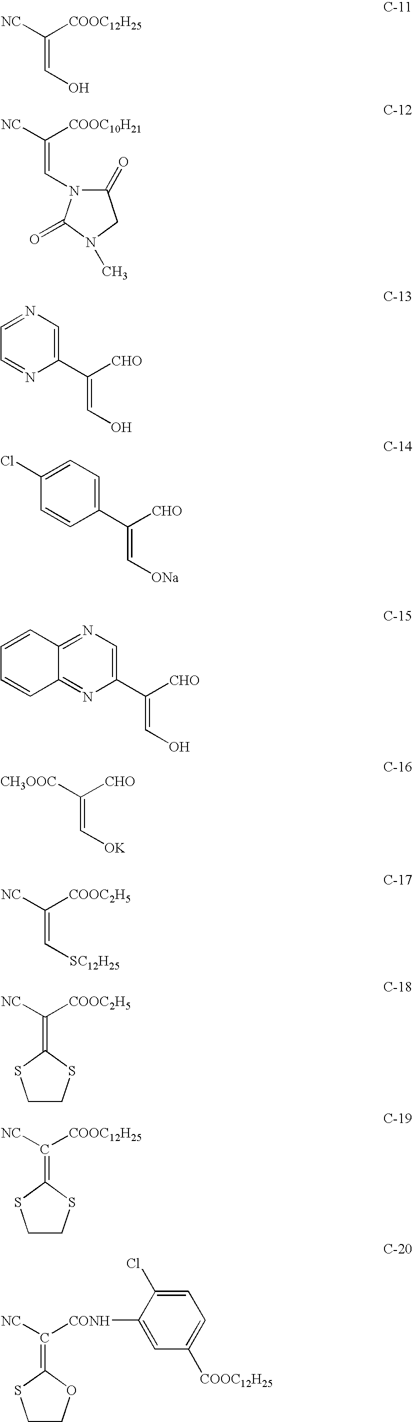

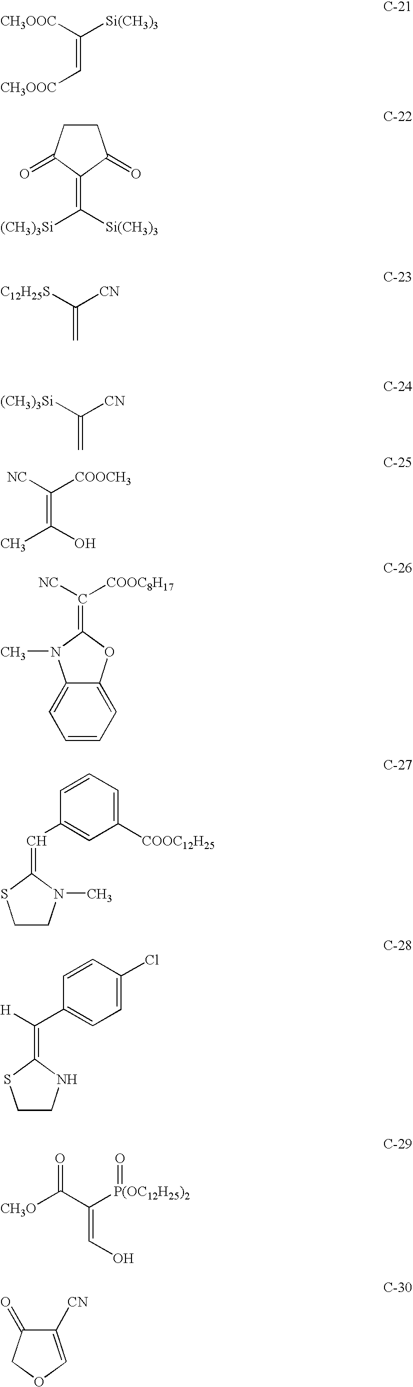

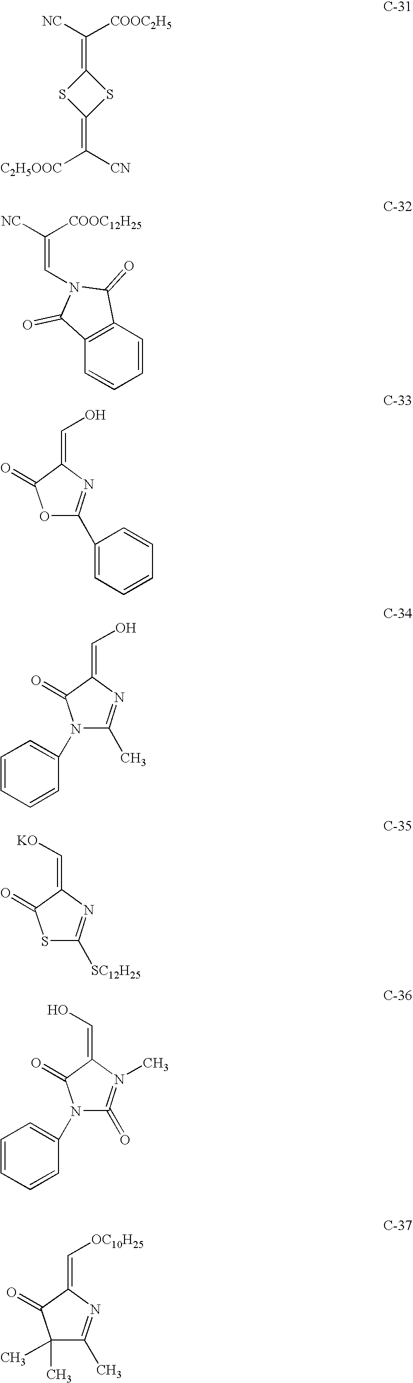

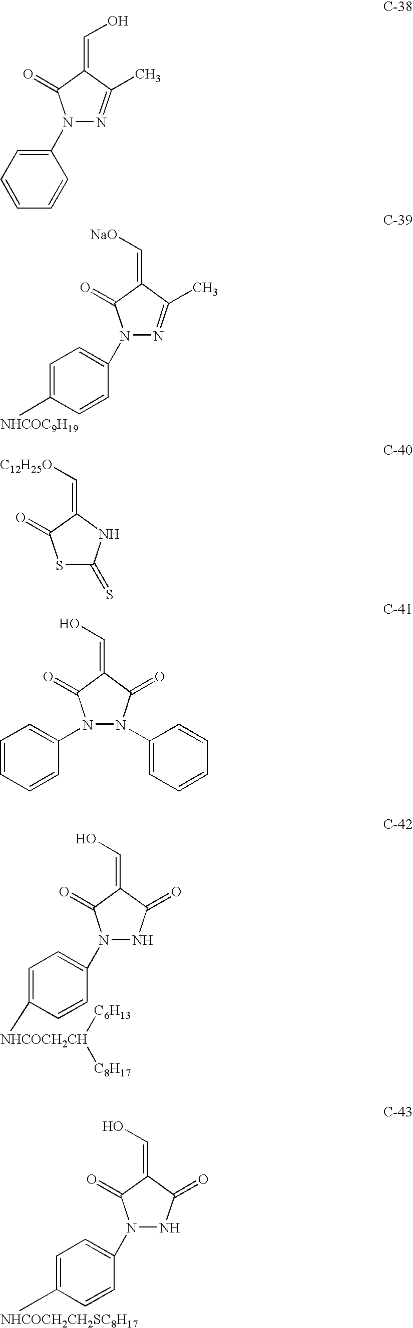

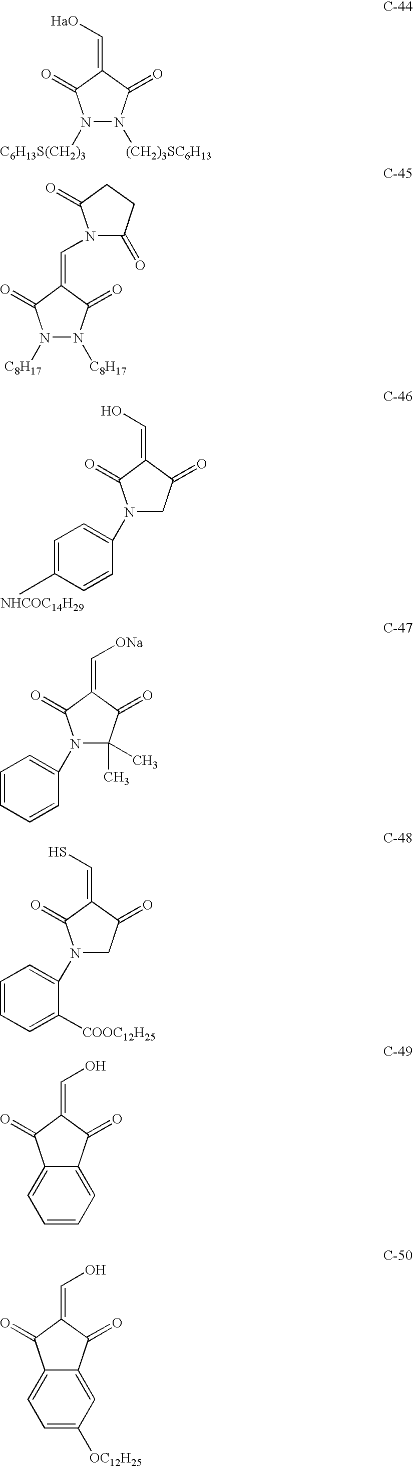

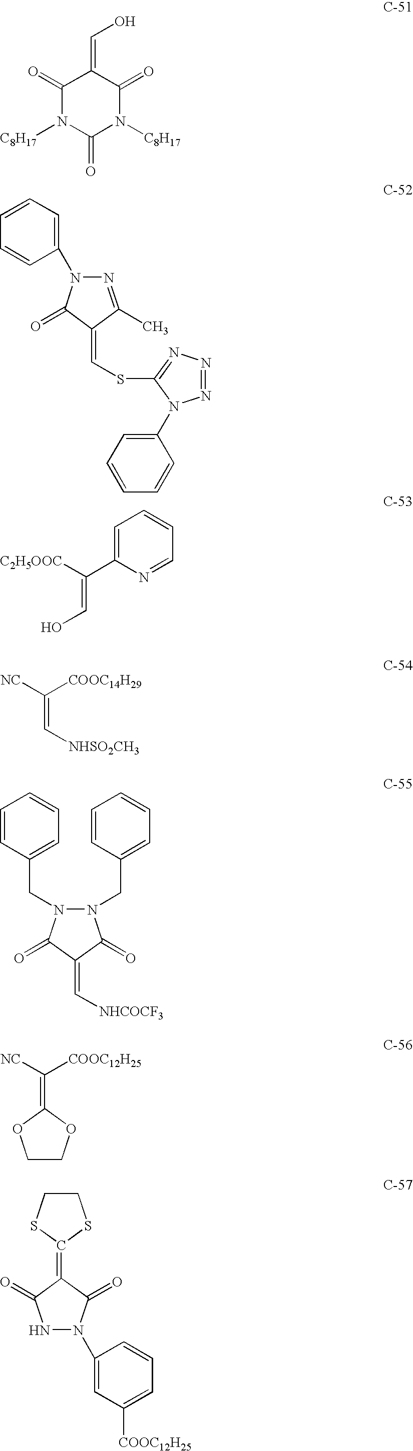

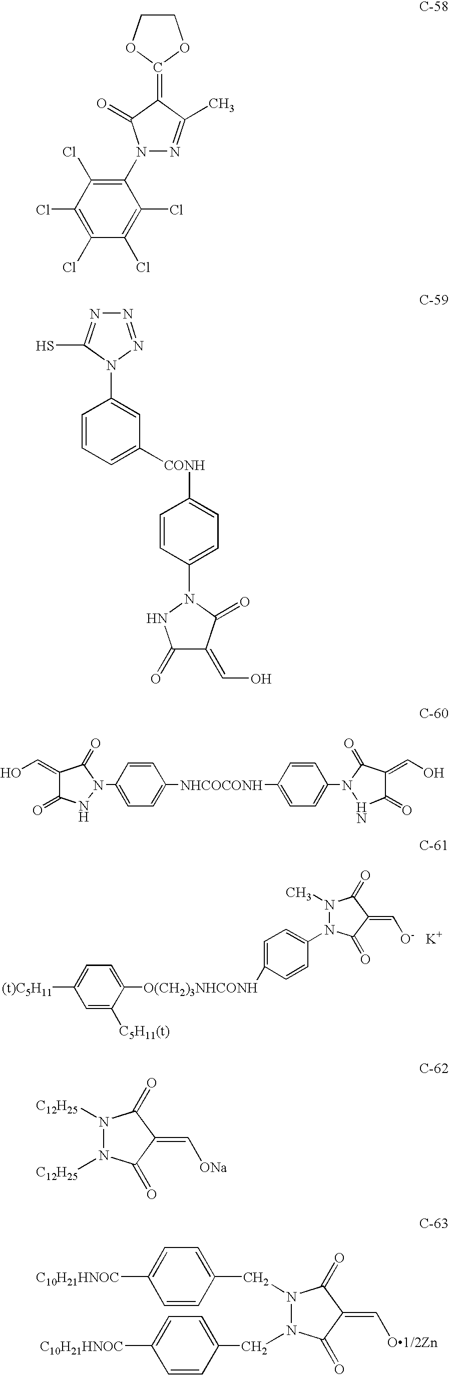

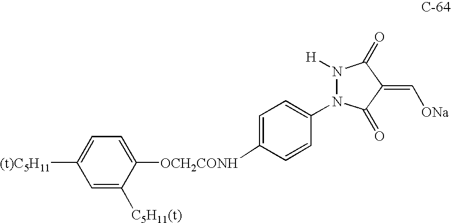

The amount of contrast increasing agent incorporated in the photothermographic recording material of this invention is preferably 0.1-0.001 mol per mol of silver, but more preferably 0.05-0.005 mol.

Others

The binders used in the light sensitive layer and the light non-sensitive layers of the photothermographic recording material of this invention may be any of appropriate hydrophilic binders (water soluble binders or latexes) or hydrophobic binders (binders soluble in organic solvents), but the binders of all layers are preferably soluble in the same solvents, for example, every binder of the light sensitive layer, the intermediate layers, and the protective layer is preferably an organic solvent type binder, or a hydrophilic binder.

Binders suitable for each layer are transparent or translucent and generally colorless, including natural polymers, synthetic polymers or copolymers and film forming media. Exemplary examples thereof include water soluble binders such as gelatin, gum arabic, (poly)vinyl alcohol, hydroxyethyl cellulose, casein, and starch; as well as hydrophobic binders such as cellulose acetate, cellulose acetate butylate, (poly)vinyl pyrrolidine, (poly)acrylic acid, poly(methylmethacrylic acid), (poly)vinyl chloride, (poly)methacrylic acid, copoly(styrene-maleic acid anhydride), copoly(styrene-acrylonitrile), copoly(styrene-butadiene), (poly)vinyl acetals [e. g., (poly)vinyl formal, and (poly)vinyl butyral], (poly)esters, (poly)urethanes, phenoxy resin, (poly)vinylidene chloride, (poly)epoxides, (poly)carbonates, (poly)vinyl acetate, cellulose esters, and (poly)amides, but preferable are hydrophobic binders such as polyvinyl butyral, cellulose acetate, cellulose acetate butyral, polyester, polycarbonate, polyacrylic acid, and polyurethane, and specifically preferred are hydrophobic binders such as polyvinyl butyral, cellulose acetate, cellulose acetate butyrate, and polyester, as well as latexes which are obtained by polymerization in water with an emulsion polymerization method or a suspension polymerization method using monomers of binder resins.

Preferably employed as main solvents to dissolve hydrophobic binders include alcohols, such as methanol, ethanol, and propanol; ketones, such as acetone, and methyl ethyl ketone; dimethyl formamide; dimethyl sulfoxide; and methyl cellosolve.

The Tg of binders in the light sensitive layer is preferably at least 40° C., more preferably 40-120° C., still more preferably 40-100° C., and specifically preferably 40-80° C. In cases when it is less than 40° C., sensitivity (being speed) under high humidity is undesirably increased (meaning line width of text being wider) due to increased developability. Further, when it is more than 120° C., it is not desirable that developability is lowered due to slow heat transfer because the Tg is almost the same as the thermal development temperature.

To control the amount of light and wavelength distribution of light transmitted through the light sensitive layer, it is preferred to form ancillary layers, such as a filter layer on the same side as the light sensitive layer, or an anti-halation dye layer and a so-called backing layer on the opposite side of the light sensitive layer, or to allow a dye or pigment to be contained in the light sensitive layer. In these ancillary layers, slipping agents may be added such as polysiloxane compounds, wax, or liquid paraffin.

Further, in the photothermographic material of this invention, various surface active agents may be employed as coating aids, and of these, a fluorochemical surface active agent is preferably employed to improve electrical charging characteristics and to prevent defects such as patchy coating.

The light sensitive layer of the photothermographic material of this invention may consist of plural layers, and to adjust contrast, the layer structure may be a higher sensitivity layer on a lower sensitivity layer, or a lower sensitivity layer on a higher sensitivity layer.

Further, examples of preferable image tone control agents usable in this invention are disclosed in RD No. 17029.

In the photothermographic recording material of this invention, an antifogging agent may be employed. These additives may be incorporated in any of the light sensitive layer, the intermediate layers, the protective layer or other formative layers.

To the photothermographic recording material of this invention, employed may be a surface active agent, antioxidation agent, or a plasticizer. The compounds described in RD No. 17029, June 1978, pp. 9-15, are preferably employed for these additives and above other additives.

Low Heat Shrinkable Substrate

The preferable low heat shrinkable substrate of this invention, for use of the photothermographic material for printing plate making, exhibits an absolute value of the rate of dimension change in both MD (being the machine direction=the longitudinal direction) and TD (being the transverse direction=the lateral direction) is in the range of 0.001-0.06%, preferably 0.001-0.04%, but more preferably 0.001-0.02%, at 120° C. being equivalent to the temperature of thermal development, for 60 seconds, to prevent dimension changes of the plate due to the heat during thermal development.

Determination of the foregoing rate of dimension change is conducted as follows: The substrate is marked at a certain length in the MD and TD directions at 23° C. and 55% RH, after which the substrate is heated at 120° C. for 60 seconds, and is again subjected to humidity conditioning at the conditions of 23° C. and 55% RH for 3 hours. Then, the length of each direction is measured, and the rate of dimension change is evaluated. The rate of dimension change is expressed as a positive or negative percentage value, as the value after heating is subtracted from the value before heating and the resulting value is divided by the value before heating.

The film of the base material of the substrate is preferably a thermoplastic resin. From the viewpoint of dynamic strength, dimensional stability under heat, and transparency, preferred is a polyester resin. More preferred is an aromatic polyester resin, and specifically preferred are polyethylene-terephthalate and polyethylene naphthalate. The thickness of these films is preferably between 50-500 μm, more preferably between 75-300 μm, and still more preferably between 90-200 μm.

To achieve the foregoing rate of dimension change, the substrate of this invention is subjected to the following heat treatment.

The heat treatment of this invention is desirably conducted as much as possible under conditions of lowered conveying tension, and increased heat treatment time, in order to not impede progress of heat shrinkage, and to minimize the subsequent dimension change during heat treatment (and/or thermal development). Treatment temperature is preferably in the range of (Tg of polyester film +50° C.)-(Tg of polyester film +150° C.), and conveying tension is preferably 9.8-2,000 kPa in this temperature range, more preferably 9.8-980 kPa, and still more preferably 9.8-490 kPa. The treatment time is preferably 30-10 minutes, and more preferably 30-5 minutes. By maintaining the above temperature range, conveying tension range and temperature, deterioration of flatness of the substrate caused by partial differences during heat treatment is prevented, and minute scratches from friction against conveyance rollers can also be prevented.

In this invention, a longitudinal relaxation treatment or a transversal relaxation treatment conducted after heat setting of before heat treatment is also a preferable embodiment. Further, to obtain the desired rate of dimension change, heat treatment is necessary at least once, but may be conducted more than two times as appropriate. Further, the heat treated polyester film is cooled from a temperature around its Tg to room temperature, after which the film is wound up. To prevent deterioration of flatness due to cooling, it is preferred to cool to room temperature past the Tg at a rate of at least 5° C./sec.

The time of the heat treatment is controlled by changing the film conveying rate or the length of the heat treatment zone. In cases when the heat treatment time is too brief, this invention is not effective, and dimensional stability under heat of the substrate deteriorates. Further, if it is more than 60 min., deterioration of flatness and transparency of the substrate is exhibited, and the substrate is not suitable as the photothermographic recording material. Adjustment of tension during the heat treatment is possible by adjusting torque of the winding roller or the out-feed roller. Further, it is possible to achieve tension control by adjusting the loading of the dancer roller provided in the production process. In cases when the tension is changed during heat treatment or during cooling after heat treatment, a dancer roller may be provided before or after the process or during the process, and the desired tension state is set up by adjusting the loading.

The substrate of this invention is preferably provided with a subbing layer before application of a thin silicon oxide layer. When providing such a subbing layer, preferably employed are an acryl resin, a polyester resin, an acryl modified polyester resin, a polyurethane resin, a vinylidene chloride resin, a polyvinyl alcohol resin, a cellulose ester resin, a styrene resin, and gelatin. Further, added may be a cross-linking agent such as a triazine type, an epoxy type, a melamine type, an isocyanate-type including a block isocyanate, an aziridine-type, or an oxazoline type; inorganic particles such as colloidal silica; a surface active agent; a viscosity increasing agent; a dye; and an antiseptic agent.

It is preferable to provide an antistatic layer on the opposite side of a thin silicon oxide layer. The antistatic layer of this invention comprises an antistatic agent and a binder.

A metal oxide is preferably employed as an antistatic agent. Examples--of such metal oxides preferably include ZnO, TiO₂, SnO₂, Al₂O₃, In₂O_{3,} SiO₂, MgO, BaO, MoO₂, and V₂O₅, as well as their multiple oxides. Specifically, from the viewpoint of miscibility with a binder, electrical conductivity and transparency, SnO₂ (being tin oxide) is preferred. As examples containing a different atom, Sb, Nb, or a halogen atom may be added to SnO₂. The added amount of the different atom is preferably in the range of 0.01-25 mol %, but the range of 0.1-15 mol % is specifically preferred. Tin oxide is preferably in the form of an amorphous sol or crystalline particles. In the case of a water based coating, an amorphous sol is preferred, and in the case of a solvent based coating, it is in the form of crystalline particles. Specifically, from the viewpoint of ecology and handling during operation, the amorphous sol form of a water based coating is preferred.

A production method of the amorphous sol may be either of the following methods, a method to prepare by dispersing SnO₂ micro-particles into an appropriate solvent, or a method to prepare by decomposition reaction of a solvent soluble Sn compound in the solvent, these crystalline particles are described in detail in JP-A Nos. 56-143430 and 60-258541. Production methods of these electrically conductive metal oxide micro-particles may be any one of the following methods or a combination of them. The first method is one in which metal oxide micro-particles are prepared by baking, after which the particles are heat treated under the presence of different kinds of atoms; the second is that different kinds of atoms are presented during preparation of metal oxide micro-particles while baking; and the third being oxygen defect is introduced by a decrease of oxygen concentration during baking.

The average particle diameter of the primary particles employed in this invention is 0.001-0.5 μm, but preferably 0.001-0.2 μm. The solid content coverage of the metal oxide employed in this invention is 0.05-2 g/m², but preferably 0.1-1 g. Further, the volume fraction of metal oxide in the antistatic layer of this invention is 8-40 volume %, but preferably 10-35 volume %. The above range may vary due to color, form and composition of metal halide oxides, but from the viewpoint of transparency and electrical conductivity, the above range is most preferable.

A binder comprising the antistatic layer may preferably use the same resin as that of the above subbing layer. Specifically, from the viewpoint of dispersibility and electrical conductivity of the metal oxide, preferred are polyester, acryl modified polyester, acryl resin, or cellulose ester.

The thickness of the antistatic layer is preferably 0.30-0.70 μm, from the viewpoint of transparency and prevention of an uneven or nonuniform coating (interference unevenness), but more preferable is 0.35-0.55 μm. In cases when it is less than 0.30 μm, the desired electrical conductivity at a high temperature cannot be maintained, and abrasion resistance when a BC layer is provided is deteriorated, both results being undesirable. Further, when it exceeds 0.70 μm, interference unevenness becomes very obvious, and commercial value is decreased, and further transparency is decreased, resulting in a non-viable product.

As a coating method of the subbing layer and the antistatic layer, commonly known as appropriate coating-methods may be employed. It is preferable to apply the following method alone or in combination, for example, a kiss coating method, reverse coating method, die coating method, reverse kiss coating method, offset gravure coating method, the Meyer bar coating method, roller brush method, spray coating method, air-knife coating method, dip-coating method, and curtain coating method.

### EXAMPLE

The present invention will now be described based on examples, but embodiments of this invention are by no means limited to these examples.

The evaluation methods of the samples in the following examples are as follows.

Water Vapor Transmission Rate

The method of determination of the water vapor transmission rate was based on JIS-Z-208 (known as the Dish Method), in which the PET film, coated with a vapor barrier layer, was arranged to face the coated surface.

Humidity Resistance of Photographic Characteristics Exposure

Exposure was conducted on the prepared photothermographic material using a laser exposure device of a single channel, cylindrical interior surface method, loaded via a semiconductor laser having a beam diameter (being a FWHM of ½ of beam strength) of 12.56 μm, laser power of 50 mV, and output wavelength of 783 nm, under the conditions of a mirror rotation number of 60,000 rpm and an exposure time of 1.2×10⁻⁸ sec; In this case, the overlap coefficient was set to 0.449, and the laser energy density on the surface of the photothermographic material was set to 75 μJ/cm².

Thermal Development Treatment

Development was conducted using a film processor Model 2771 manufactured by Imation Corp., via thermal development at 120° C. for 48 sec. In this case, exposure was conducted at an ambience of 23° C. and 50% RH, and development was conducted under the conditions of 23° C., 20% RH and also 80% RH respectively.

Evaluation of Photographic Characteristics

From the photothermographic recording material of this invention, two samples were prepared. One was humidified at 23° C. and 80% RH (being high humidity) for 12 hrs., and the other one was humidified at 23° C. and 20% RH (being low humidity). Under the same conditions, exposure was conducted for 50 μm text line width, and thermal development.

Dmax (being maximum density) of the sample humidified at 23° C. and 20% RH was evaluated after thermal development. Density measurement was conducted using a Macbeth TD904 densitometer.

Further, sensitivity fluctuation to humidity change was determined via the following equation.

Sensitivity fluctuation (μm)=[text line width after development of a sample humidified at 23° C./80% RH (being high humidity)]−[text line width after development of a sample humidified at 23° C./20% RH (being low humidity)]

Text line width was measured using a micro densitometer.

The lower value indicated reduced sensitivity fluctuation to humidity change.

Blocking Resistance

From each of the samples, six sheets of 3.5×10 cm were cut, and stored at 30° C. and 80% RH for one day, so as not to be in contact with each other. After that, the six pieces were stacked under a load of 800 g for one day. Then, after the samples were stored under the conditions of 23° C. and 50% RH while loaded, the pieces were separated, whereby the state of adhesion was evaluated. Evaluation criteria were the following:

Rank A: the pieces separated without resistance, and no trace of adhesion was observed.

Rank B: the pieces separated without resistance, but traces of adhesion were observed over less than 20% of the total area.

Rank C: the pieces separated without resistance, but traces of adhesion were observed over 20-60% of the total area.

Rank D: the pieces separated with a little resistance, but traces of adhesion were observed over more than 20% of the total area.

Rank E: the pieces separated with some resistance, and peeling of the hydrophilic binder was observed.

Preparation of Substrate for Photothermographic Recording Material

PET resin was obtained as described below.

PET Resin

Added to 100 weight parts of dimethyl terephthalate, and 65 weight parts of ethylene glycol, was 0.05 weight parts of magnesium acetate anhydrate as an ester exchange catalyst, and an ester exchange reaction was conducted under common practice. To the obtained product, added were 0.05 weight parts of antimony trioxide and 0.03 weight parts of trimethyl phosphate ester. Subsequently, subjected to a gradual temperature rise and pressure reduction, polymerization was conducted at 280° C. and 66.5 Pa, to obtain polyethylene terephthalate (PET) resin having an intrinsic viscosity of 0.70.

Using the PET resin as obtained above, biaxial oriented PET film with a subbing layer was prepared as described below.

Biaxial Oriented PET Film with Subbing Layer

Pelletized PET resin was subjected to vacuum drying at 150° C. for 8 hrs., after which the resin was melt-extruded at 285° C. in layers from a T die, and said layers were stuck together on a 30° C. cooling drum while electrostatically impressed, and cooled to solidification, to obtain unoriented film. This unoriented film was stretched at a factor of 3.2 times in the longitudinal direction. Onto the obtained uniaxial oriented film, the following subbing layer coating composition A (exhibiting a solid content of 4 weight %) was applied on one side, to obtain a wet layer thickness of 2 g/m² using a kiss coating method. Subsequently, using a tenter type transverse stretching machine, the film was stretched at a ratio of 50% to the total transverse drawing ratio at 90° C. in the first stretching zone, after which the resulting film was further stretched to a factor of 3.3 of the total transverse stretch ratio at 220° C. in the second stretching zone. Further, a preheat treatment was conducted at 70° C. for two seconds, after which heat setting was conducted at 150° C. for five seconds in the first setting zone, and then at 220° C. for 15 sec. in the second setting zone. Subsequently, to the transverse (being width) direction, 5% relaxation treatment was conducted at 160° C., and after the film was released from the tenter, relaxation treatment in the longitudinal (being straight side) direction was conducted at 140° C. utilizing a difference of peripheral velocity, and then the film was cooled to room temperature over 60 sec. Further, the film was released from clips, and slit and wound up respectively, to obtain 125 μm thick, biaxial oriented PET film. The Tg of this biaxially oriented PET film was 79° C.

Subbing Layer Coating Composition A

| | |
|---|---|
| Acryl copolymer | 40 weight parts |
| Compound (G) | 50 weight parts |
| Polyglycerin | 10 weight parts |

Water was added to bring the total solid content to 4% in the coating composition.

Acryl copolymer: methyl methacrylate/ethyl acrylate/acrylic acid/hydroxyethyl methacrylate/acrylamide=30/47.5/10/2.5/10 (respectively weight average molecular weight 500,000) 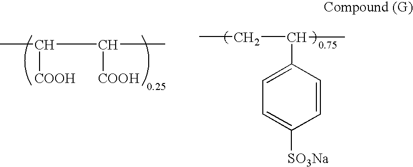
Coating of Polyvinylidene Chloride Layer

The coating compositions were prepared to obtain polyvinylidene chloride layers the compositions of which were described in Table 1. After the coating composition was filtered at an absolute filtration accuracy of 20 μm, the filtered composition was coated onto the biaxial oriented PET film at 50 m/min. prepared as above using a reduced pressure extrusion coater, to be a wet layer thickness of 15 μm for a dry thickness of 3 μm, and dried at 70° C. for four minutes.

Latex Refer to Table 1

Surface Active Agent

Matting Agent

Heat Treatment of Substrate

Using a suspension type heat relaxation apparatus, the substrate was relaxation treated at a temperature of 180° C., a conveying tension of 230 kPa, and a time of 15 sec., and further cooled to room temperature at 10° C./min., and then wound up.

Antistatic Layer

Subbing layer coating composition B was applied onto the heat treated substrate using a wire bar to obtain a dry thickness of 0.35 μm. Thus, the substrate with the antistatic layer was prepared.

Subbing Layer Coating Composition B

| | |
|---|---|
| Tin oxide sol (being a SnO₂ sol which was synthesized | 500 g |
| with a method described in JP-B 35-6616, heated and condensed | |
| to achieve a solid content of 8.3 weight %, and adjusted its | |
| pH to 10, using aqueous ammonia) | |
| Acryl modified polyester resin (being B-1 described in | 200 g |
| JP-A 2002-156730, being a solid component of 17.8 weight %) | |
| Water | 300 g |

Preparation of Photothermographic Recording Material
Coating of Backing Layer Side

Backing layer coating composition 1 and backing protective layer coating composition 1, which contained the following components, were each filtered using filters having an absolute filtration accuracy of 20 μm before coating, after which both coating compositions were simultaneously applied as a multiplayer coating onto the foregoing substrate with the antistatic layer, using an extrusion coater, to result in a total wet layer thickness of 60 μm, at the rate of 50 m/min., and dried at 70° C. over 4 min.

Backing Layer Coating Composition 1

| | | |
|---|---|---|
| Methyl ethyl ketone | 16.4 | g/m² |
| Infra red dye-A | 17 | mg/m² |
| Stabilizing agent B-1 (Sumilizer BPA, | 20 | mg/m² |
| produced by Sumitomo Chemical Co., Ltd.) | | |
| Stabilizing agent B-2 (Tomisoab 77, from Yoshitomi | 50 | mg/m² |
| Pharmaceutical Industries, Ltd.) | | |
| Cellulose acetate propionate (being CAP 504-0.2, | 0.5 | g/m² |
| produced by Eastman Chemical Co., Ltd.) | | |
| Cellulose acetate propionate (being CAP 482-20, | 1.5 | g/m² |
| produced by Eastman Chemical Co., Ltd.) | | |
| Surface active agent 1: C₉F₁₇SO₃Li | 20 | mg/m² |
| Surface active agent 2: C₉F₁₇O(C₂H₄O)nOC₉F₁₇ | 100 | mg/m² |
| n = 22 | | |

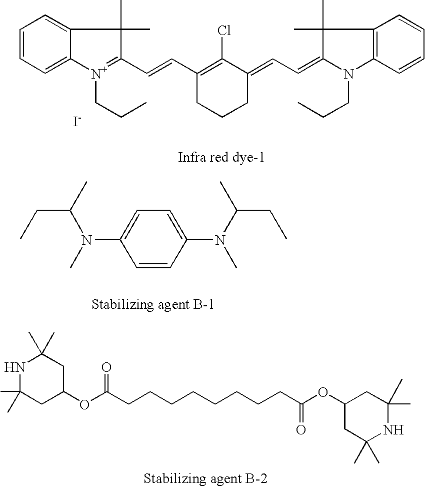

Backing Protective Layer Coating Composition 1

| | | |
|---|---|---|
| Methyl ethyl ketone | 22 | g/m² |
| Surface active agent 3: C₉F₁₇(C₂H₄O)OC₉F₁₇ | 22 | mg/m² |
| Surface active agent 1 | 10 | mg/m² |
| Cellulose acetate propionate (being CAP 482, | 2.0 | g/m² |
| Produced by Eastman Chemical Co., Ltd.) | | |
| Silica (being Syloid 74, at an average | 12 | mg/m² |
| particle diameter of 7 μm, produced by | | |
| Fuji Davison Co., Ltd.) | | |

Preparation of Silver Halide Particle

To 900 ml of pure water, dissolved were 7.5 g of gelatin and 10 mg of potassium bromide, after adjusting temperature to 35° C. and pH to 3.0. Added to this solution over 10 minutes were, 370 ml of an aqueous solution contained 74 g of silver nitrate, and an aqueous solution containing potassium bromide and potassium iodide at the mol ratio of (96/4) and 5×10⁻⁶ mol/l of (NH₄)₂RhCl₅(H₂O) via a controlled double-jet method, while keeping pAg at 7.7. After that, added was 0.3 g of 4-hydroxy-6-methyl-1,3,3a,7-tetrazaindene, and pH was adjusted to 5.0 with NaOH, to obtain silver halide particles comprising cubic silver iodobromides having an average particle diameter of 0.06 μm, a coefficient of variation of projected diameter area of 8%, and a [100] surface ratio of 86%. Desalting treatment, by adding a flocculating agent to this emulsion, was conducted via a coagulation process, after which 0.1 g of phenoxyethanol was added, and pH and pAg were adjusted to 5.9 and 7.5 respectively.

Preparation of Organic Aliphatic Acid Silver Emulsion

To 300 ml of water, added was 10.6 g of behenic acid, and heated to 90° C. to dissolve it, and 31.1 ml of 1M sodium hydroxide was added while stirring adequately, after which the mixture was allowed to stand for one hour. After that, it was cooled to 30° C., after which 7.0 ml of 1 M phosphoric acid was added, and 0.01 g of bromosuccinimide was added while stirring adequately. Subsequently, silver halide particles prepared in advance were added in the silver content ratio of 10% to behenic acid at 40° C., and allowed to stand for one hour while stirring.

To this emulsion, polyvinyl butyral dissolved in ethyl acetate was added, and after stirred adequately, it was left to stand, to separate the ethyl acetate phase containing silver behenate particles and silver halide particles from a water phase. After the water phase was removed, the silver behenate particles and the silver halide particles were collected by centrifugal separation. After which, 20 g of synthesized Zeorite A-3 (being spherical particles), produced by Tosoh Corp., and 22 ml of isopropyl alcohol were added, and left to stand for one hour and were then filtered. Further, 3.4 g of a binder, described in Table 1, and 23 ml of isopropyl alcohol were added and stirred sufficiently at 35° C. at a high rate to be dispersed, whereby preparation of organic aliphatic acid silver emulsion was accomplished.

Light Sensitive Layer Emulsion Component

| | | |
|---|---|---|
| Organic aliphatic acid silver Emulsion | 1.4 | g (Ag)/m² |
| Pyridinium hydrobromide perbromide | 1.5 × 10⁻⁴ | mol/m² |
| Calcium bromide | 1.8 × 10⁻⁴ | mol/m² |
| 2-(4-chlorobenzoyl)benzoic acid | 1.5 × 10⁻³ | mol/m² |
| Infrared spectral sensitizing dye 1 | 4.2 × 10⁻⁶ | mol/m² |
| 2-mercapto benzimidazole | 3.2 × 10⁻³ | mol/m² |
| 2-tribromomethylsulfonyl quinoline | 6.0 × 10⁻⁴ | mol/m² |
| 4-methylphthalic acid | 1.6 × 10⁻³ | mol/m² |
| Tetrachlorophthalic acid | 7.9 × 10⁻⁴ | mol/m² |
| 1,1-bis(2-hydroxy-3,5-dimethylphenyl)- | 4.8 × 10⁻³ | mol/m² |
| 3,5,5-trimethyl hexane | | |
| Infrared dye-A | 3 × 10⁻⁵ | mol/m² |
| Nucleating agent (described in Table 1) | 0.5 × 10⁻³ | mol/m² |

As a solvent, methyl ethyl ketone, acetone or methanol was employed as appropriately.

Infrared spectral sensitizing dye 1

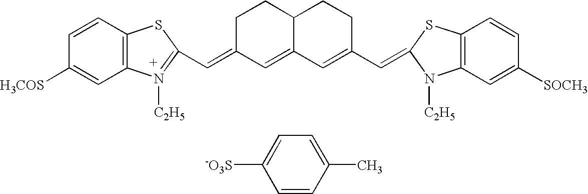

Surface Protective Layer Component

A surface protective layer coating composition was prepared as follows.

Cellulose acetate butyrate (being CAP 381-20, produced by Eastman Chemical Co., Ltd.)/cellulose acetate propionate (being CAP 504-05, produced by Eastman Chemical Co., Ltd.)=2/8 4 g/m²
Phthalazine 3.2×10⁻³ mol/m²

As a solvent, methyl ethyl ketone, acetone or methanol was appropriately employed.

Coating of Vapor Barrier Layer

Coating compositions to form the vapor barrier layers components of which were described in Table 1 and the following column, were prepared and filtered at an absolute filtration accuracy of 20 μm. The coating composition was applied on the surface protective layer of the photothermographic material prepared as above, using a reduced pressure extrusion coater at the rate of 50 m/min., resulting in a wet layer thickness of 15 μm, and dried at 70° C. for 4 min. for a dry thickness of 3 μm, resulting in photothermographic material sample Nos. 1-11.

| | |
|---|---|
| Water | 10 g |
| Latex (as described in Table 1) | 450 g |
| Latex emulsion (as described in Table 1) | 150 g |
| Surface active agent 4 | (added to become 20 mg/m²) |
| (C₈F₁₆OC₆H₄SO₃Na) | |
| Matting agent (being Syloid 74X6000, | (added to become 30 mg/m²) |
| at an average | |
| Particle diameter of 6 μm, produced | |
| by Fuji Davison Co., Ltd.) | |

C-65

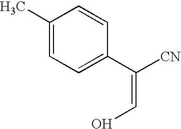

TABLE 1

| | | | Vapor barrier | | | | |
|---|---|---|---|---|---|---|---|
| | | | layer | | | Photographic | |
| | Vinylidene | | | Water | | characteristics | |
| | chloride | | | vapor | | | High |
| | layer | | | transmission | Nucleating | Low | humidity |
| | | PVDC | Latex/ | rate | agent | humidity | Sensitivity |
| Remarks | Component | ratio | Wax | g/m² · 24 hr | Type | Dmax | rise |
| Comp. 1 | — | — | — | — | AA | 3.0 | 0.4 |
| Comp. 2 | A | 93 | — | — | AA | 3.4 | 0.26 |
| Comp. 3 | — | — | 95/5 | 3 | AA | 3.6 | 0.16 |
| Comp. 4 | B | 40 | 95/5 | 3 | AA | 3.7 | 0.12 |
| Inv. 1 | A | 93 | 98.5/1.5 | 34 | AA | 4.0 | 0.08 |
| Inv. 2 | A | 93 | 95/5 | 3 | AA | 4.0 | 0.07 |
| Inv. 3 | A | 93 | 90/10 | 1 | AA | 4.2 | 0.04 |
| Inv. 4 | A | 93 | 90/10 | 1 | BB | 4.3 | 0.02 |
| Inv. 5 | D | 98 | 90/10 | 1 | AA | 4.3 | 0.02 |
| Inv. 6 | D | 98 | 90/10 | 1 | BB | 4.4 | 0.01 |

Note:
Comp. = comparative sample
Inv. = this invention

In Table 1:

Vinylidene chloride layer: layer containing polyvinylidene chloride

A: copolymer of vinylidene chloride/methyl acrylate/hydroxyethyl acrylate =93/5/2 respectively

B: copolymer of vinylidene chloride/methyl acrylate/hydroxypropyl acrylate =40/50/10

D: copolymer of vinylidene chloride/ethyl acrylate/acrylic acid =98/1/1, and annealed at 60° C. for 12 hrs.

Vapor barrier layer latex (a/b=80/20)

a: styrene butyl acrylate/grycidyl methacrylate=20/40/40 (at a Tg of 20° C.)

b: styrene/butyl acrylate/grycidyl methacrylate=59/1/40 (at a Tg of 45° C.)

Vapor barrier layer wax

EMUSTAR-0135 paraffin (exhibiting a melting point of 61° C., produced by Nippon Seiro Co., Ltd.)

Nucleating agent AA: C-65
BB: C₂H₅O—(C═O)—C(CN)═C(H) (OH)

PVCD: polyvinylidene chloride

As is apparent from Table 1, it was proven that the samples of the photothermographic-recording material employing the substrate for the photothermographic recording material of the present invention were superior in humidity resistance (being density and sensitivity), and exhibited improved blocking resistance.

1. A photothermographic recording material comprising a substrate having thereon a light sensitive layer comprising organic silver salt particles, silver halide particles and a reducing agent for silver ions,
wherein a layer containing polyvinylidene chloride in an amount of at least 70 weight % based on the total weight of the layer is provided on at least one side of the substrate, and
a vapor barrier layer is provided comprising a latex and a wax on the outermost layer of the light sensitive layer.

2. The photothermographic recording material of claim 1, wherein a water vapor transmission rate of the vapor barrier layer is 1 to 40 g/m²·24 hr.

3. The photothermographic recording material of claim 2, wherein the layer containing polyvinylidene chloride is provided on the light sensitive layer side.

4. The photothermographic recording material of claim 2, wherein the light sensitive layer is formed via a solvent coating method.

5. The photothermographic recording material of claim 3, wherein the light sensitive layer is formed via a solvent coating method.

6. The photothermographic recording material of claim 2, wherein the light sensitive layer comprises a nucleating agent represented by Formula (C-1), (C-2) or (C-3); 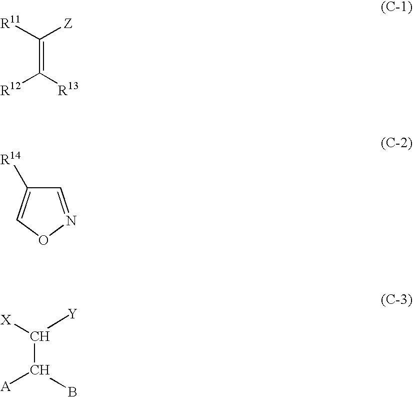
wherein in C-1, R¹¹, R¹² and R¹³ are each independently a hydrogen atom or a substituent group, Z is an electron attractive group or a silyl group, provided that pairs R¹¹ and Z, R¹² and R¹³, and R¹³ and Z may each combine with each other to form a cyclic structure,
in C-2, R¹⁴ is a substituent group,
in C-3, X and Y are each independently a hydrogen atom or a substituent group, A and B are each independently an alkoxy group, and alkylthio group, an alkylamino group, an arythio group, and anilino group, a heterocyclic oxy group, a heterocyclic thio group, or a heterocyclic amino group, provided that X and Y, and A and B, may each combine with each other to form a cyclic structure.

7. The photothermographic recording material of claim 2, wherein the substrate is a low heat shrinkable substrate.

8. The photothermographic recording material of claim 2, wherein a silver iodide content of the silver halide particles is 5 to 100 mol %.
